(19) United States
(12) Patent Application Publication
(10) Pub. No.: US 2026/0238088 A1
(43) Pub. Date: Aug. 13, 2026

(54) Fluid Cooled Heat Pipe Thermal Management System for an Electric Motor

(71) Applicant: Marquette University, Milwaukee, WI (US)

(72) Inventors: Towhidul Islam CHOWDHURY, Milwaukee, WI (US); Ayman Mohamed Fawzi EL-REFAIE, Pewaukee, WI (US)

(21) Appl. No.: 19/155,858

(22) PCT Filed: Feb. 16, 2024
(86) PCT No.: PCT/US2024/016237

§ 371 Date: Aug. 12, 2025

Related U.S. Application Data
(60) Provisional application No. 63/446,543, filed on Feb. 17, 2023.

(51) Int. Cl. H02K 9/22; B64D 27/34; B64D 33/10; H02K 5/20; H02K 9/06; H02K 9/20; H02K 11/33; H02K 21/16

(52) U.S. Cl. CPC H02K 9/225; B64D 27/34; B64D 33/10; H02K 5/203; H02K 9/06; H02K 9/20; H02K 11/33; H02K 21/16

(57) ABSTRACT

An electrical machine includes a stator comprising a plurality of windings, each of the windings comprising a first plurality of legs connected to a second plurality of legs to form a coil configuration, each of the legs in the first plurality of legs and each of the legs in the second plurality of legs comprising a duct extending from a first end to a second end of a length portion of the leg; a rotor including a plurality of permanent magnets; and power electronics, the power electronics providing an AC power supply to the stator causing the rotor to rotate. A fluid cooled chamber extends between the power electronics and the stator, the fluid cooled chamber comprising a plurality of heat pipes coupled the stator and/or the power electronics.

### CROSS-REFERENCE TO RELATED APPLICATIONS

This application claims priority to U.S. Patent Application No. 63/446,543 filed on Feb. 17, 2023, which is hereby incorporated by reference in its entirety for all purposes.

### BACKGROUND

Specific power of an electric machine is defined as the ratio of output power to total weight. High specific power electric machines are important in electrified transportation systems such as electric aircraft and other vehicles, because they reduce fuel consumption and extend the traveling range of the vehicle. However, technical challenges in electromagnetic, thermal, mechanical and manufacturing issues currently limit the specific power that can be achieved in electric machines.

One major challenge in the design of high specific power electrical machines relates to controlling losses through cooling management systems. Current commonly used cooling methods, include cooling jackets on the outside of the stator, oil spray cooling of the end winding, and encapsulating stators using resin or epoxy. In these methods, a high thermal barrier/resistance is provided between the cooling medium and the conductors. For applications where winding supply voltage is high (e.g. >800 V) or air pressure is low (e.g. <30 kPa), for example, thick insulation (e.g. >18 mil) is required to provide sufficient dielectric strength. This makes the commonly-used cooling approaches much less effective since insulation thickness represents a large thermal resistance between the winding losses/heat source and the cooling fluid/medium. Other known cooling methods, such as axial cooling channels inside slots, can provide more effective direct cooling of windings, but also require thick winding insulation, and reduce the slot fill factor, which results in increased conductor losses and decreased efficiency.

The systems disclosed herein use heat pipes to cool both the stator and power electronics resulting in unique coolant flow configurations for an electric motor. The complex integration of heat pipe with elements of the electric motor and power electronics allows for high specific power (kW/kg) rating for the electric motor.

This disclosure specifically describes cooling methods for stator windings and power electronics that can use heat pipes integrated with winding conductors to provide direct cooling to the winding and similarly can use heat pipes to provide thermal management to printed circuit boards and/or other components mounting power electronics for driving a motor. Suitable stators and heat pipes are disclosed in U.S. Patent Application U.S. patent application Ser. No. 17/702,575, entitled Stator Winding with Integrated Cooling, filed on Mar. 23, 2022, and published as US Patent Publication 2022/0320933A1 on Oct. 6, 2022, the contents of which are hereby incorporated by reference for the description of these devices.

As described in U.S. patent application Ser. No. 17/702,575, additive manufacturing methods can be used to simplify the fabrication of machine components, enable customization of conductors, windings, and heat pipes, and enable close contact between heat pipes or coolant flows and conductors. Additive manufacturing processes can employ, for example, computer-aided-design (CAD) software or 3D object scanners to direct hardware to deposit material, layer upon layer, in precise geometric shapes, adding material to create an object. As a result, these processes can produce lighter, stronger parts and systems as compared to traditional processes, which are typically subtractive processes that remove material through milling, machining, carving, shaping or other means. In addition, additive manufacturing enables conductor shapes that cannot be achieved by any other manufacturing methods.

In one example, hollow conductors can be provided in the stator winding, and heat pipes inserted directly into the hollow conductors. Referring now to FIGS. 1A-1D , a machine drive 10′ as described in U.S. patent application Ser. No. 17/702,575 is shown. The machine drive includes a rotor 13′, and a segmented stator structure 12′. Referring now specifically to FIG. 1D, the stator 12′ comprises a plurality of open-slot iron core segments 11′ aligned side by side to form a circular structure, with slots 15′ formed between each pair of adjacent open-slot core segments. Referring now also to FIG. 1B, the slots 15′ are filled with coils or windings 14′ comprising side or leg conductors 16′ and end conductors 21′, laminated cores 18′, and heat pipes 20′. The leg conductors 16′ are insulated from each other, and the insulation can be additively manufactured with the leg conductors 16′. In some applications, a heat exchanger 22′ can also be used with the stator 12′. The winding can comprise a plurality of conductive leg members 16′ arranged in layers in a first stacked configuration, with ducts formed in the leg members to receive a heat pipe 20′, as shown. As described above, the legs can be formed using additive manufacturing processes such as direct metal laser sintering, selective laser sintering/melting, selective laser beam melting, green wavelength laser melting, fuse filament fabrication and fused deposition modeling.

Referring still to FIG. 1A and B, the heat pipes 20′ can be constructed of copper or aluminum, and can include a working fluid such as water, ammonia, ethanol, alcohol, liquid helium, mercury, or sodium, indium. The heat pipes can be sized and dimensioned to be received in the ducts 17′ formed in one or both ends of hollow conductors 16′, and to cooperate with condensers of the type disclosed below for heat dissipation.

A stator constructed as described can be used, for example, in an electrical machine. The electric machine can include a stator including a plurality of open-slot iron core segments aligned in a side-by side configuration, with slots formed between each pair of adjacent open-slot core segments; and a plurality of windings of the type described above. The machine can further include a rotor including a plurality of permanent magnets. The electrical machine can also include a heat sink in thermal communication with a circuit for driving the motor, and heat pipes can also be in thermal communication with the circuit and/or heat sink.

The current disclosure addresses methods and apparatuses for fluid cooling electric motors of the type described above.

### SUMMARY

Ine one aspect, the current disclosure is addressed to an electrical machine comprising a stator having a plurality of windings each of the windings comprising a first plurality of legs connected to a second plurality of legs to form a coil configuration, each of the legs in the first plurality of legs and each of the legs in the second plurality of legs comprising a duct extending from a first end to a second end of a length portion of the leg; a rotor comprising a plurality of permanent magnets; power electronics, the power electronics providing an AC power supply to the stator causing the rotor to rotate; and a fluid cooled chamber extending between the power electronics and the stator, the fluid cooled chamber comprising a plurality of heat pipes coupled the stator and/or the power electronics.

The electrical machine can further comprise a second cooling chamber on an opposing side of the stator from the first chamber, the second cooling chamber comprising a second plurality of heat pipes extending from the stator.

The electrical machine can also include a fan in fluid communication with the fluid cooled chamber to provide a cooling fluid to the fluid cooled chamber and directing air through the power electronics.

The fluid cooled chamber can further comprise a fluid inlet in communication with a gas or liquid fluid source and the fluid outlet is configured to expend the gas or liquid fluid source from the fluid cooled chamber. The fluid cooled chamber can also comprise first and second opposing walls, a fluid inlet is provided in the first of the first and second opposing walls and a fluid outlet is provided in the second of the first and second opposing walls, and wherein the fluid inlet is laterally offset from the fluid outlet such that fluid flows across the plurality of heat pipes in the fluid cooled chamber as fluid moves from the fluid inlet to the fluid outlet. The fluid cooled chamber can also include a plurality of fins, and the plurality of heat pipes extends through the plurality of fins. The fluid cooled chamber can also comprise side walls with openings for air flow. The fluid cooled chamber can comprise walls that include a fluid inlet and a fluid outlet for directing a flow of liquid, and side walls that are solid in construction to contain liquid.

The fluid cooled chamber can also comprise first and second opposing walls, a fluid inlet can be provided in the first of the first and second opposing walls adjacent a first side of the plurality of heat pipes and a fluid outlet can be provided in the first of the first and second opposing walls adjacent a second side of the plurality of heat pipes, wherein fluid flows across the plurality of heat pipes in the fluid cooled chamber from the fluid inlet to the fluid outlet.

The heat pipes can include an outer wall surrounding a vapor space, and a wick extending between the outer wall and the vapor space. At least one of the plurality of heat pipes can be coupled to a cooling plate mounted adjacent the power electronics. At least one of the plurality of heat pipes can be sized and dimensioned to be received in an opening formed in one of the plurality of legs of the stator. The heat pipes can be rectangular in cross section and/or round in cross section. At least one of the plurality of heat pipes can terminate at a mounting surface for mounting the power electronics. at least one of the plurality of heat pipes is received in the duct in one of the plurality of windings in the stator.

The electrical machine can include a housing, and the housing can include apertures for directing air flow from a fan.

The electrical machine can include a diverter plate extending over the fluid inlet to direct the flow of fluid.

The fluid chamber can be an air cooled chamber, and an air diverter can be coupled to a housing of the electrical machine, the air diverter forming a channel for directing air flow caused by movement of the machine to an opening in the housing and into the air cooled chamber, and the air cooled chamber can also include at least one air outlet duct that is angled to cause the air exiting the air cooled chamber from re-entering the channel of the air diverter.

In another aspect, the current disclosure is addressed to an electrical machine comprising a stator comprising a plurality of windings each of the windings comprising a first plurality of legs connected to a second plurality of legs to form a coil configuration, each of the legs in the first plurality of legs and each of the legs in the second plurality of legs comprising a duct extending from a first end of a length portion of the leg to a second end of the length portion of the leg; a rotor comprising a plurality of permanent magnets; power electronics, the power electronics providing an AC power supply to the stator causing the rotor to rotate; and a first fluid cooled chamber extending between the power electronics and the stator, the first fluid cooled chamber comprising a plurality of heat pipes coupled within the ducts in the plurality of windings in the stator and a second plurality of heat pipes coupled to the power electronics; and a second fluid cooled chamber extending from an opposing side of the stator winding, the second fluid cooled chamber comprising a second plurality of heat pipes extending from an opposing end of the ducts in the plurality of windings of the stator.

In yet another aspect, the current disclosure is addressed to an electrical machine comprising a stator comprising a plurality of windings each of the windings comprising a first plurality of legs connected to a second plurality of legs to form a coil configuration, each of the legs in the first plurality of legs and each of the legs in the second plurality of legs comprising a duct extending from a first end of a length portion of the leg to a second end of the length portion of the leg; a rotor comprising a plurality of permanent magnets, the rotor coupled to a propellor to rotate the propellor; power electronics, the power electronics providing an AC power supply to the stator causing the rotor to rotate; and a first fluid cooled chamber extending between the power electronics and the stator, the first fluid cooled chamber comprising a plurality of heat pipes coupled within the ducts in the plurality of windings in the stator and a second plurality of heat pipes coupled to the power electronics.

These and other aspects of the invention will become apparent from the following description. In the description, reference is made to the accompanying drawings which form a part hereof, and in which there is shown a preferred embodiment of the invention. Such embodiment does not necessarily represent the full scope of the invention, and reference is made, therefore, to the claims herein for interpreting the scope of the invention.

### BRIEF DESCRIPTION OF THE DRAWINGS

FIG. 1A is a side view of a segmented stator structure with heat pipes in a tooth-winding permanent magnet (PM) machine constructed in accordance with the disclosure;

FIG. 1B is a perspective view of a winding assembly in the machine of FIG. 1A;

FIG. 1C is an exploded view of a winding in the machine of FIG. 1A;

FIG. 1D is a partial view of the stator of FIG. 1A, illustrating hollow conductors in the windings;

FIG. 2 is an exploded view of a motor of the type described with reference to FIGS. 1A-1D configured for use with a propellor in an aeronautical application;

FIG. 3 is an exploded view of the propellor and cone of FIG. 2;

FIG. 4 is a schematic drawing of a dual chamber air cooling condenser suitable for use with a motor such as the motor of FIG. 2;

FIG. 5 is a cutaway side view of the dual chamber air cooling condenser of FIG. 4;

FIG. 6 is a perspective view of the heat pipes of FIG. 5 coupled to the power electronics and extending into the rear air cooled condenser chamber;

FIG. 7 is an alternate perspective view of the heat pipes of FIG. 5 coupled to the power electronics and extending into the rear air cooled condenser chamber;

FIG. 8A is a cross-sectional view of a structure of the heat pipes of FIG. 5;

FIG. 8B is another cross-sectional view of a structure of the heat pipes of FIG. 5;

FIG. 9 is a perspective view of a bank of rectangular heat pipes for cooling a stator;

FIG. 10 is a schematic drawing of a single chamber air cooling condenser;

FIG. 11 is a cutaway side view of the single chamber air cooling condenser of FIG. 10;

FIGS. 12 and 13 are perspective views of rectangular heat pipes as coupled to stator;

FIG. 14 illustrates round heat pipes coupled to the power electronics;

FIG. 15 is a schematic drawing of a single chamber liquid cooling condenser;

FIG. 16 is a cutaway side view of the single chamber liquid cooling condenser of FIG. 15;

FIG. 17 is a cutaway view of the heat pipes extending between the stator and the power electronics of FIG. 15;

FIG. 18 is a perspective view of rectangular heat pipes coupled to stator;

FIG. 19 is a perspective view of round heat pipes connected to power electronics;

FIG. 20 is a schematic of a dual chamber liquid cooling condenser;

FIG. 21 is a cutaway view of the liquid cooled front condenser chamber;

FIG. 22 is an alternative schematic drawing of a single chamber air cooling condenser similar to FIG. 10;

FIG. 23 is a cutaway side view of the single chamber air cooling condenser of FIG. 22; and

FIG. 24 is a perspective view of a portion of the side of the single chamber air cooling condenser of FIG. 22 illustrating an air diverter.

### DETAILED DESCRIPTION

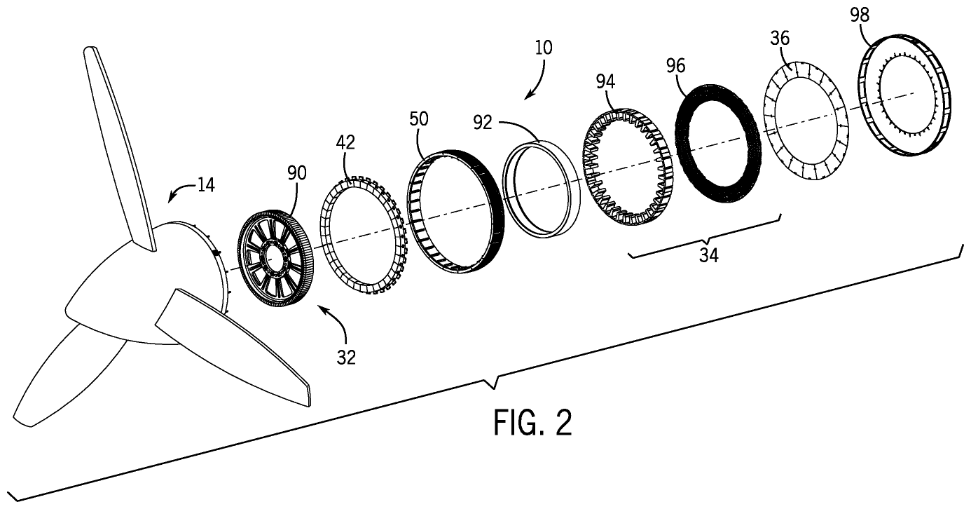

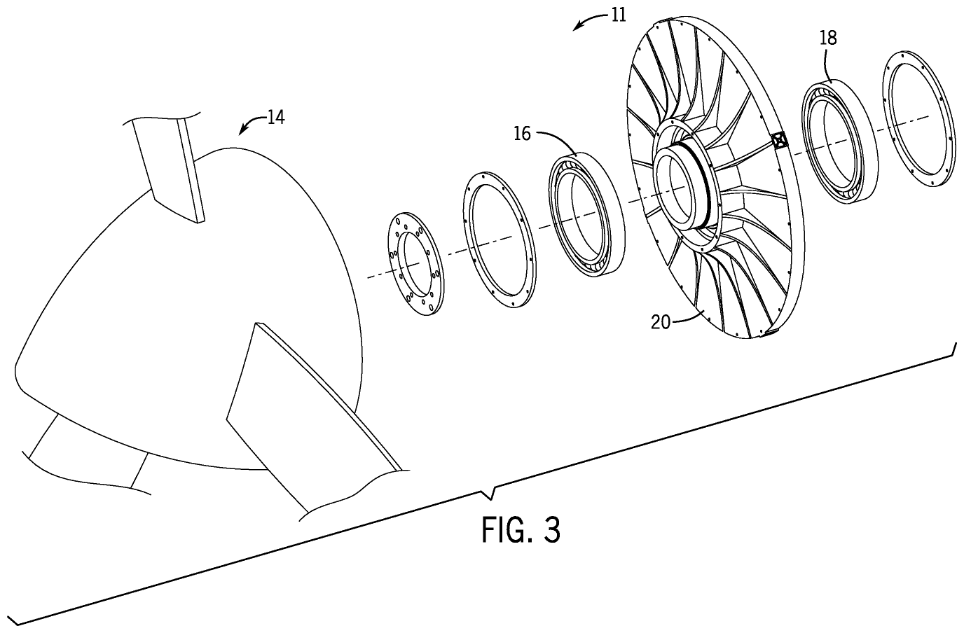

Referring now to FIGS. 2 and 3, an electrical machine, here motor 10, which is constructed in accordance with the disclosure and configured for use with a propellor in an aeronautical application is shown. As illustrated here, the motor 10 is connected to a propellor and cone 14 through a bearing assembly to the motor 10. The bearing assembly can include, as illustrated here, a front bearing 16 and rear bearing 18 which are connected to a bearing housing 20, which can be mounted to an airplane chassis. The motor 10 illustrated here includes a rotor hub mounting permanent magnets 90 forming a rotor 32, a liquid cooled chamber 42, cooling jacket with fins 50, a magnet radial retaining sleeve and axial retaining rings 92, stator core 94 and coil 96, which together form stator 34, power electronics 36 for driving the motor 10, and a power electronics support structure 98. Although a single liquid cooled chamber 42 is illustrated here, the motor 10 can include a dual chamber air cooling condenser, a single chamber air cooling condenser, or a dual chamber liquid cooled condenser, as described below.

Referring still to FIGS. 2 and 3, power electronics 36 can convert DC power into AC power and feed the AC power to the stator coil 96, which in turn creates a rotating magnetic field that drives the rotor 32. The power electronics 36 can, for example, be connected to a battery, and use an inverter constructed of semiconductor devices such as transistors or insulated-gate bipolar transistors (IGBTs) to convert the DC power into AC power. The inverter can be controlled by a microcontroller or other control system which determines the frequency, voltage, and waveform of the AC output based on the desired speed and torque of the motor. The output of the inverter can be connected to the stator windings 96 of the motor, which creates a rotating magnetic field when an AC current flows through the windings 96. The rotating magnetic field produced by the stator induces an electromagnetic force on the rotor 32 which causes the rotor to rotate, thereby driving the motor, and in this example, the propellor. In some applications, sensors such as encoders or hall effect sensors may be used to provide feedback on the motor's speed, position, and other parameters, and the control system may make adjustments to the inverter to maintain the desired performance of the motor.

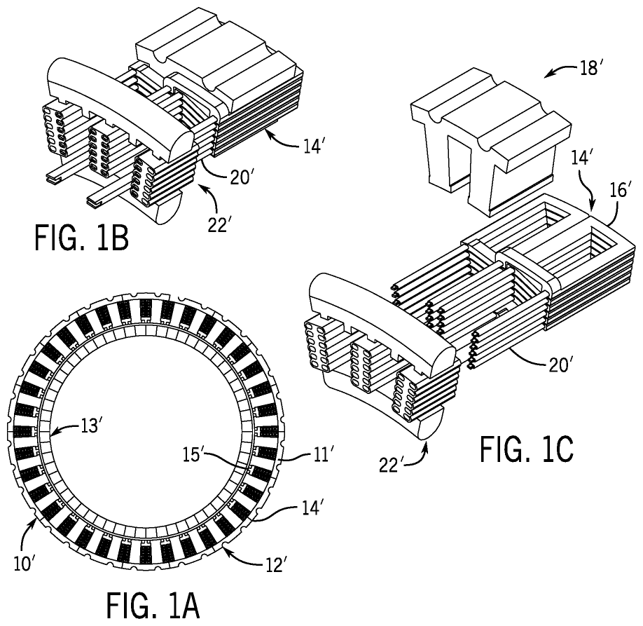

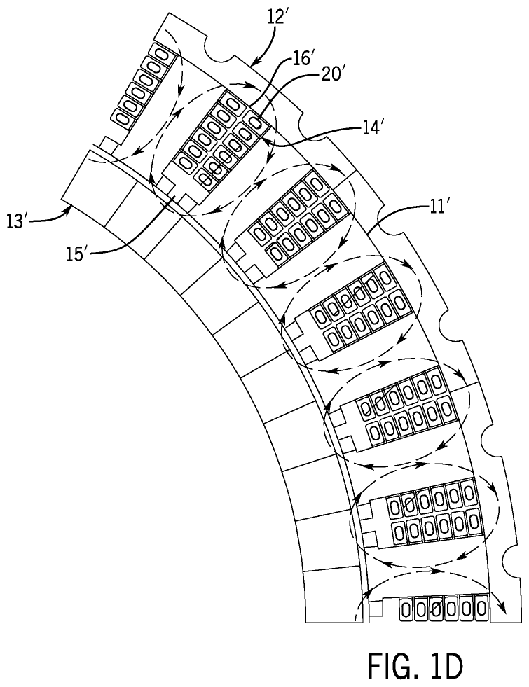

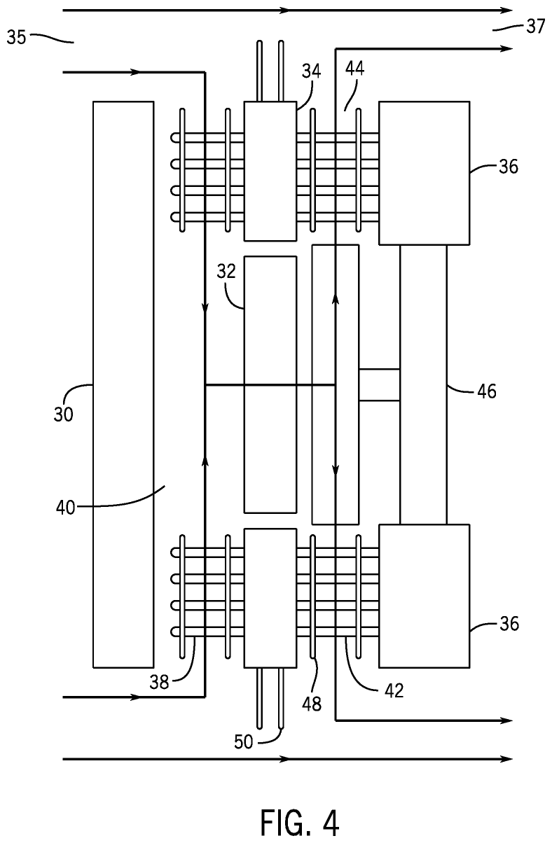

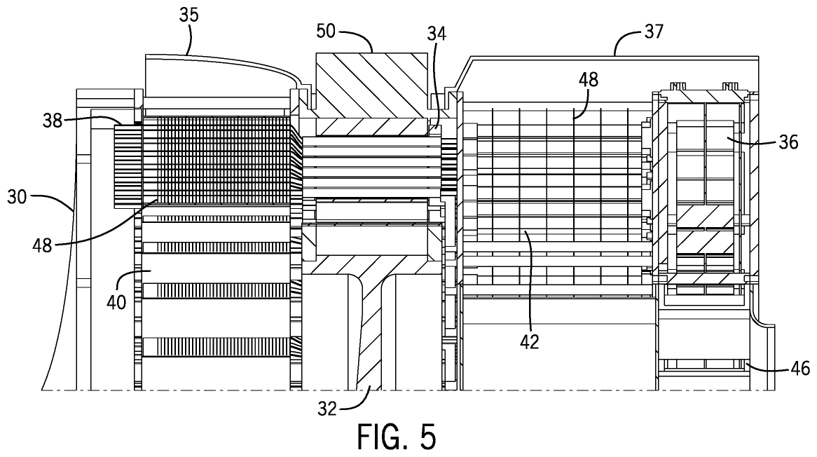

Referring now to FIGS. 4 and 5, a schematic drawing and a cutaway side view of motor 10 using a dual chamber air cooling condenser are shown. Referring first to FIG. 4, the motor 10 comprises a housing 30, rotor 32, stator 34, and power electronics 36 for driving the rotor 32. Heat pipes 38, of the type described above with reference to FIG. 1A-1D , for cooling the stator 34 are coupled to the stator 34 and extend into a front air cooled condenser chamber 40 located between housing 30 and the rotor 32 and stator 34. A second set of heat pipes 42 are coupled to the power electronics 36 and extend into a rear air cooled condenser chamber 44 located between the power electronics 36 and the rotor 32 and stator 34. A radial fan 46 adjacent the power electronics 36 draws air flow in through a front condenser air inlet 35, into the front air cooled condenser chamber 40, and rotor 32. The air is then redirected by the radial fan 46 into the rear air cooled condenser chamber 44 and exits the motor 10 through the rear condenser air outlet 37. The same radial fan 46 draws air flow in through the rear of the motor 10. The air is then redirected air cooled condenser chamber the radial fan through the power electronics 36 and exits the motor 10. A cooling fin 48 can be provided on each set of heat pipes 38 and 42, and a cooling jacket fin 50 can be provided on the stator 34 for additional cooling. The corresponding components are similarly illustrated in the cut away view of FIG. 5.

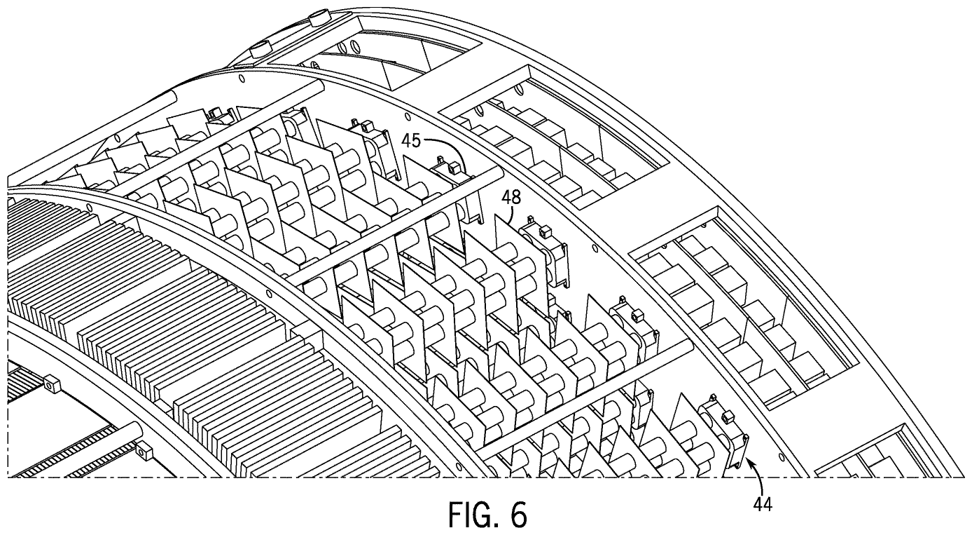

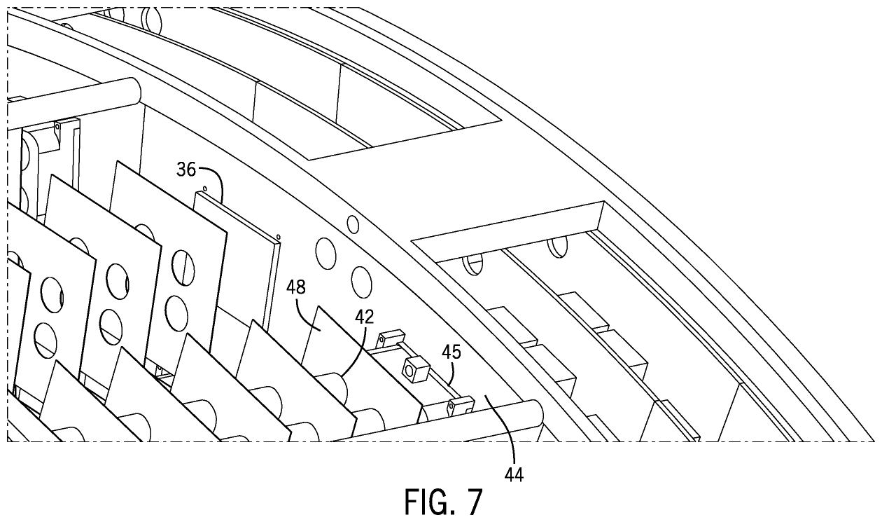

Referring now to FIGS. 6 and 7, perspective views of the heat pipes 42 coupled to the power electronics 36 and extending into the rear air cooled condenser chamber 44 is shown. As illustrated here, the heat pipes 42 for the power electronics 36 are round in cross-section, which provides a high heat carrying capacity. A plurality of planar fins 48 are spaced through the air cooled condenser chamber 44, with the heat pipes 42 extending through the fins 48. The fins 48 on heat pipes 42 increases the heat pipe's 42 effective surface area available for cooling. The heat pipes 42 can be coupled to a heat sink or cold plate 45 which is mounted to semiconductor devices used to drive motor 10, such as GaN electronics, as described below. The sides of the air cooled condenser chamber 44 are open to allow air to flow easily through the chamber 44 and around heat pipes 42.

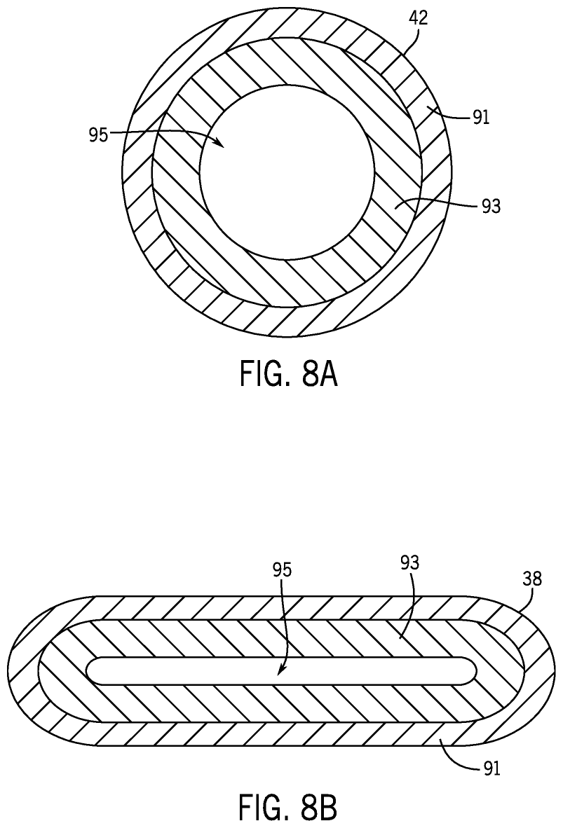

Referring now also to FIGS. 8A-8B , cross-sectional views of heat pipes 38 and 42, respectively, are shown. As can be seen here, a hollow porous structure or “wick” can line the interior wall of the heat pipes 38 and 42, and the cross-sectional structure of the heat pipe therefore consists of 3 regions, the outer wall 91, the wick 93, and the vapor space 95 as shown in FIGS. 8A and 8B. The wall (non-porous) and the wick (sintered porous) are structures which can be made of copper while the vapor space is hollow. This causes liquid, such as water, injected into the heat pipe to be absorbed within the porous wick structure due to capillary action. All air is removed from the heat pipe by implementing a vacuum and the heat pipe is crimped shut on one end after a small quantity of liquid water is injected into it. On the evaporator (hot) side of the heat pipe where it contacts stator 34, cooling fluid such as water held in its porous structure evaporates to a vapor. This vapor travel down the hollow part towards the condenser (cold) side that extends into the air-cooled condenser chamber 44. Upon reaching the condenser chamber 33, the vapor condenses to a liquid and gets drawn back into the porous structure. Capillary action causes the liquid to travel back to the evaporator side through the annular porous structure. In the present application, water has been shown to be a suitable fluid. Other types of cooling fluids can be used, as described above.

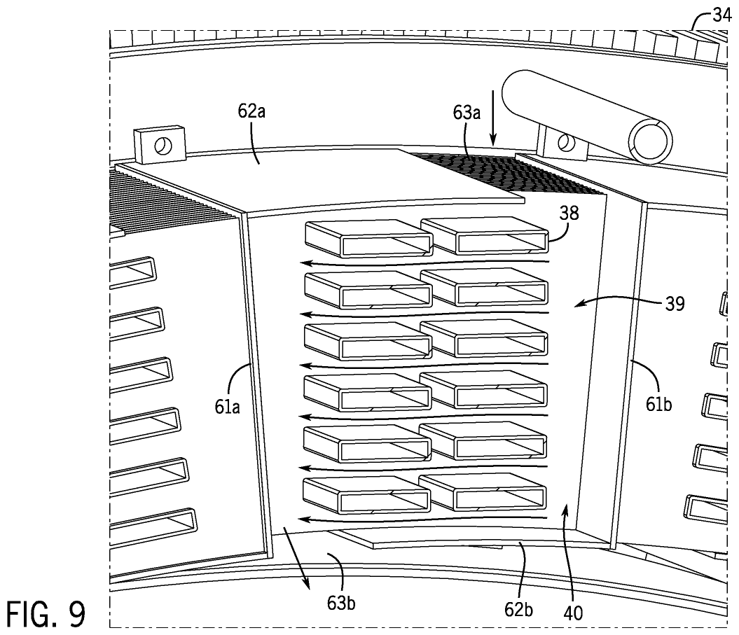

Referring now to FIG. 9, a bank 39 of rectangular heat pipes 38 extending in the front air cooled condenser chamber for cooling stator 34 is shown. As illustrated here, the bank of heat pipes 39 can include a plurality of heat pipes 38 arranged in horizontal rows and vertical columns, extending into conductors in the stator 34.

Referring still to FIG. 9, the front air condenser chamber 40 includes vertical side walls 61a and 61b are on opposing sides of the bank of heat pipes 38. Solid air diverter plates 62a, 62b are positioned to extend horizontally over the bank of heat pipes 38. Top diverter plate 62a extends from left vertical side wall 61a, over the bank 39 of heat pipes, to a point substantially aligned with a trailing vertical edge of the rightmost column of heat pipes 38. A space 63a, therefore, exists between the top side plate 62a and the right vertical side wall 61b for conducting air flow. Bottom air diverter plate 62b extends from the right side wall 61b to a point substantially aligned with a trailing vertical edge of the leftmost column of heat pipes 38. A space 63b, therefore, exists between the bottom side plate 62b and the left vertical side wall 61a for conducting air flow each end of the bank of heat pipes 39. As illustrated, air entering through the space or opening 63a is directed across the horizontal rows of the heat pipes 38 and exits through the bottom space or opening 63b.

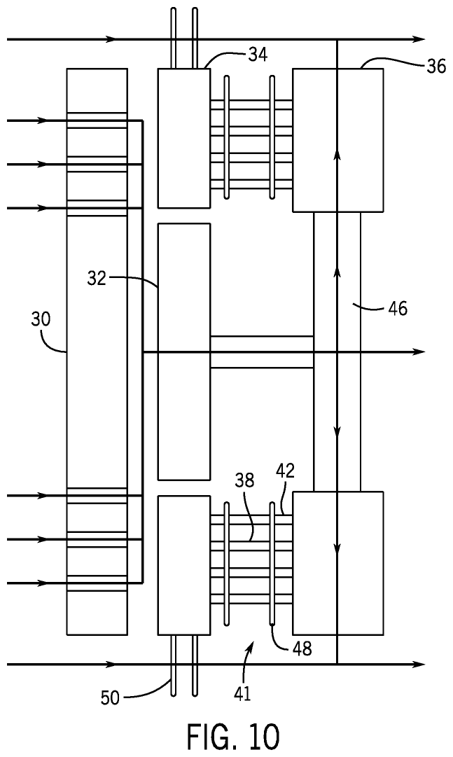

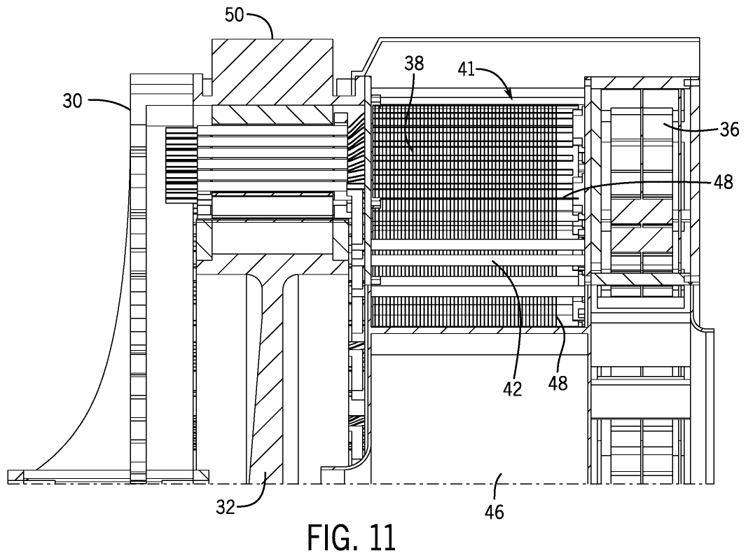

Referring now to FIGS. 10 and 11, a schematic drawing and a cutaway side view of motor 10 using a single chamber air cooling condenser are shown. Like numerals are used to reference similar parts in the description above. Referring first to FIG. 10, the motor 10 comprises a housing 30, rotor 32, stator 34, and power electronics 36, as described above. Here, heat pipes 38 for cooling the stator 34 extend from the stator 34 and heat pipes 42 for cooling the power electronics 36 extend from power electronics 36 into the air cooled condenser chamber 41 between the power electronics 36 and stator 34. A radial fan 46 is, again, provided adjacent the power electronics 36, drawing air flow through holes in the housing 30 and rotor 32 into the air cooled condenser chamber 41. A cooling fin 48 can be provided on the heat pipes 39, and a cooling jacket fin 50 can be provided on the stator 34 for additional cooling. The corresponding components are similarly illustrated in the cutaway view of FIG. 11. Referring again to FIG. 10, in an alternative embodiment, the relative position of the power electronics 36 and stator 34 can be reversed.

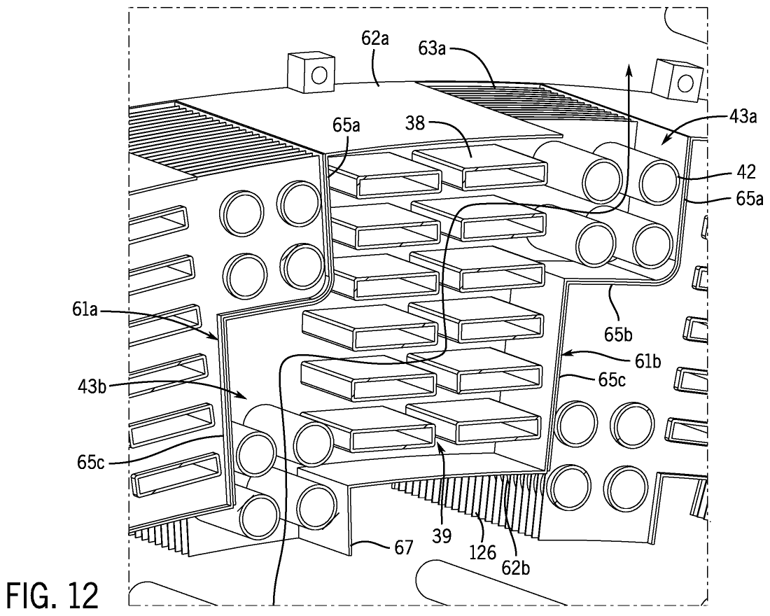

Referring now to FIG. 12, a cutaway view of the heat pipes 38 and 42 extending within air cooled condenser chamber 41 is shown. As illustrated here, the heat pipes 42 for the power electronics 36 are round in configuration, and the stator heat pipes 38 are rectangular in configuration. Here, the side walls 61a and 61b of individual segments of the condenser chamber 41 are step shaped, including an upper vertical section 65a, a lower vertical section 65c, and a horizontal section 65b extending therebetween. As described above, solid air diverter plates 62a, 62b are positioned to extend horizontally over the bank of heat pipes 38. Top diverter plate 62a extends from left vertical side wall 61a, over the bank 39 of heat pipes, to a point substantially aligned with a trailing vertical edge of the rightmost column of heat pipes 38. A space 63a, therefore, exists between the top side plate 62a and the right vertical side wall 61b for conducting air flow. Bottom air diverter plate 62b extends from the right side wall 61b to a point substantially aligned with a trailing vertical edge of the leftmost column of heat pipes 38. A space 63b, therefore, exists between the bottom side plate 62b and the left vertical side wall 61a for conducting air flow each end of the bank of heat pipes 39. Here, upper and lower banks 43a and 43b of heat pipes 42, which are similarly arranged in a rows and columns configuration, are positioned between the horizontal section 65b of each wall and the corresponding space or opening 63a or 63b, aligned with the space. As illustrated, a vertical air diverting wall 67 may extend from one of the top or bottom air diverter plates, extending away from the banks of heat pipes 39 and 43a and 43b to aid in the conduction of air flow. When the motor 10 is in operation, a diverter can be used to bring the air to zero velocity relative to the motor 10, allowing debris carried by the air to separate. The air's momentum can then be flipped by the radial fan 46 which blows air out radially through the rear condenser chamber 41 and the power electronics 36 such that the exiting air does not re-enter the motor thermal management system (TMS). In alternate embodiments, instead of a diverter, air can be channeled through the housing 30 and past the rotor 32 to cool the magnets in the rotor 32.

As illustrated, air flows vertically through the opening 63b, past heat pipes 43b, and then can follow horizontal path across spaces in banks 39 and 43a of heat pipes, exiting vertically through the opening 63a. The air diverter plates provide a fluid flow channel which guides air flow over the maximum heat pipe surface area. As shown here, for the rectangular heat pipes 38, air flow can be maximized by directing air horizontally, along the long sides of the rectangular pipes. As illustrated, the lower bank of heat pipes 42 may be offset to align adjacent the vertical air diverting wall 67.

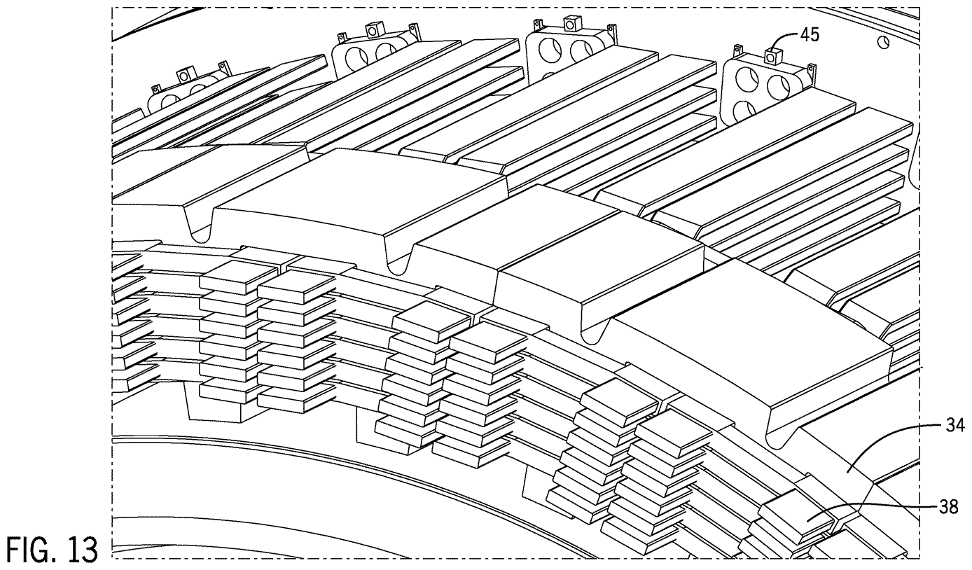

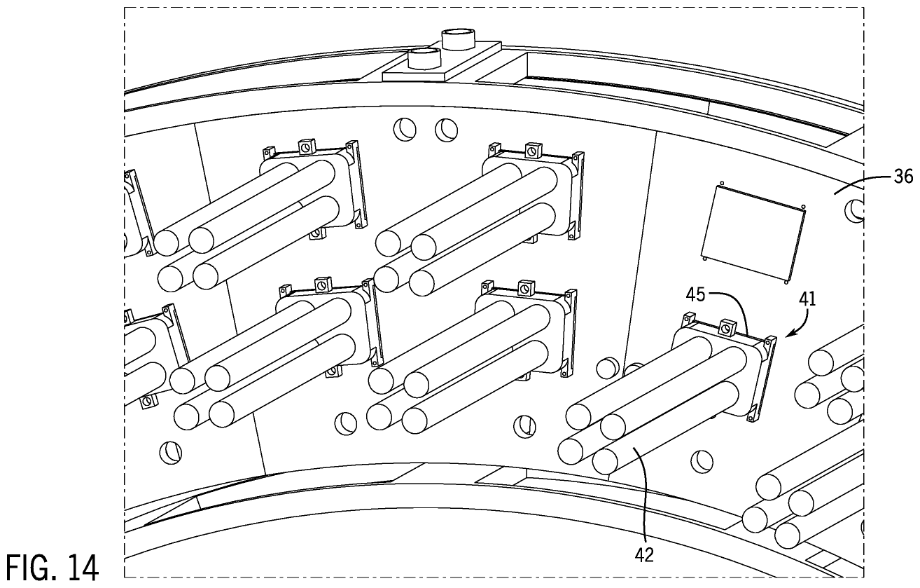

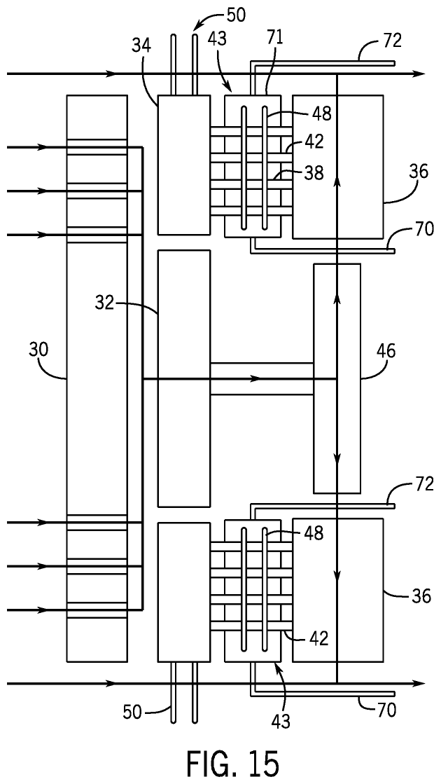

Referring now to FIGS. 13 and 14, the rectangular heat pipes 38 are illustrated coupled to stator 34, and the round heat pipes 42 are illustrated coupled to the power electronics 36, respectively. The round heat pipes 42 can connect to a heat sink or cold plate 45 which is mounted to electronic or semiconductor drivers such as GaN electronics (FIG. 14), as described above. The cold plate 45 may include apertures that are sized and dimensioned to receive the round heat pipes 42.

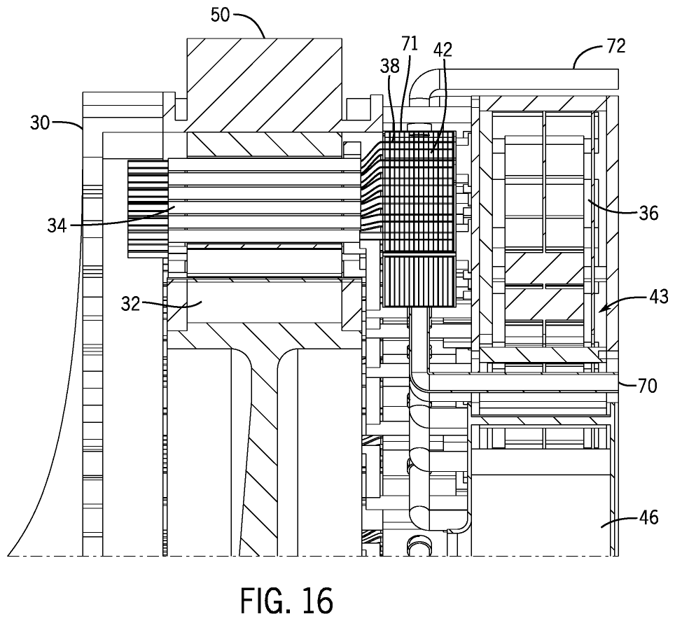

Referring now to FIGS. 15 and 16, a schematic drawing and a cutaway side view of motor 10 using a single chamber liquid cooling condenser are shown. Like numerals are used to reference similar parts in the description above. Referring first to the schematic of FIG. 15, the motor 10 again comprises a housing 30, rotor 32, stator 34, and power electronics 36, as described above. Here, heat pipes 38 for cooling the stator 34 and 42 for cooling the power electronics 36 are again coupled between the stator 34 and power electronics 36, extending through a liquid cooled condenser chamber 71 between the power electronics 36 and stator 34. Here, the liquid cooled condenser chamber includes an inlet 70 for receiving cooling fluids and a liquid outlet 72 for dispensing the fluids. Liquid can be provided to the condenser chamber 71 by way of a tank and pump configuration, by way of example, A radial fan 46 can, again, be provided adjacent the power electronics 36, drawing air flow through apertures or openings in the housing 30 and rotor 32. The air is then redirected by the radial fan 46 through the power electronics 36, drawing air flow through the housing 30 and rotor 32. A cooling jacket fin 50 can be provided on the stator 34 for additional cooling. The corresponding components are similarly illustrated in the cutaway view of FIG. 16. Referring again to FIG. 15, although the coolant flow is illustrated with the fluid inlet positioned between the power electronics and fan, the direction of the coolant flow can also be reversed, and the fluid flow inlet can be directed first to the cooling jacket 50 on the stator 34 prior to entering the chamber 71. Here, the fluid flows radially inwards rather than radially outwards.

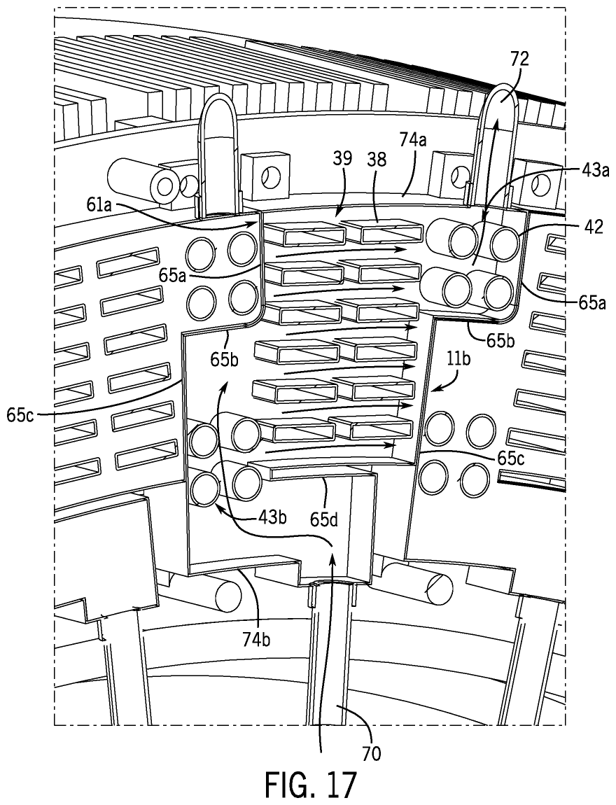

Referring now to FIG. 17, a cutaway view of the heat pipes extending between the stator 34 and the power electronics 36 in the schematic of FIG. 15 is shown. As illustrated here, the heat pipes 42 for the power electronics 36 are round in configuration, and the stator heat pipes 38 are rectangular in configuration. Here, the side walls 61a and 61b of individual segments of the condenser chamber 71 are again step shaped, including an upper vertical section 65a, a lower vertical section 65c, and a horizontal section 65b extending therebetween. One of the side walls 61a and 61b may also include an additional horizontal section 65d, extending below the bank of heat pipes 38. As illustrated here, the horizontal sections 65d can be provided as a U-shaped bend. Here, upper and lower plates 74a and 74b extend between the right and left side walls 61a and 61b, across a bank 39 of heat pipes 38, and two banks 43 of heat pipes 42, upper bank 43a and lower bank 43b, which are positioned between the horizontal wall sections 65b and the upper and lower plates 72a and 72b, respectively. The upper plate 74b includes an outlet 72 which is positioned directly above the upper bank 43a of heat pipes 42. An inlet 70 is provided in the lower plate 74b, and can be, for example, centered below the bank 39 of heat pipes 38. As illustrated, coolant enters inlet 70 and is directed toward horizontal wall section 65d, which causes the fluid to flow over the lower bank 43b of heat pipes 42. Coolant flows horizontally across the bank 39 of heat pipes 38 and vertically across the upper bank 43a of heat pipes 42 to outlet 72.

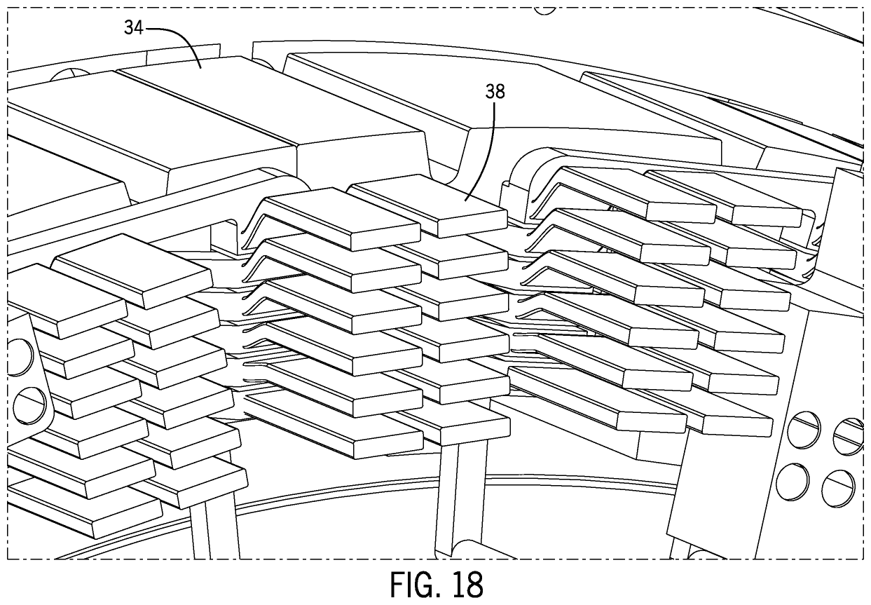

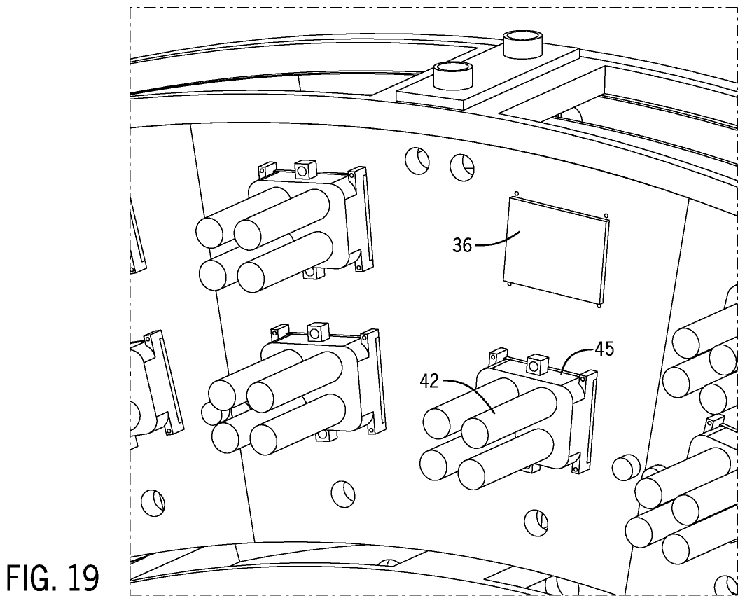

Referring now to FIGS. 18 and 19, the rectangular heat pipes 38 are illustrated as coupled to stator 34, and the round heat pipes 42 are illustrated connected to power electronics 36, respectively. The round heat pipes 38 can, again, connect to a cold plate or heat sink, as described above.

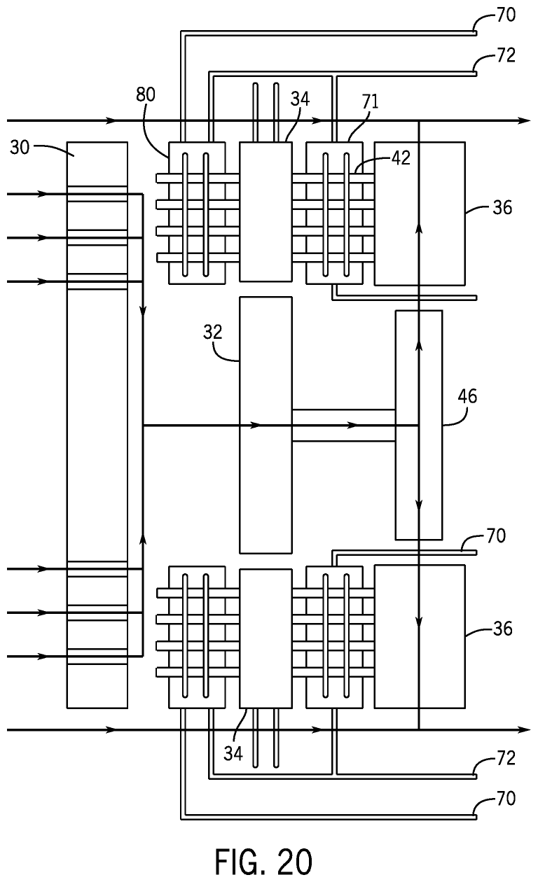

Referring now to FIG. 20, a schematic of a motor 10 using a dual chamber liquid cooling condenser are shown. Like numerals are used to reference similar parts in the description above. Referring first to the schematic to the left, the motor 10 again comprises a housing 30, rotor 32, stator 34, and power electronics 36, as described above. Here, heat pipes 38 for cooling the stator 34 and the power electronics 36 are again coupled between the stator 34 and power electronics 36, extending through a liquid cooled rear condenser chamber 71 between the power electronics 36 and stator 34. Heat pipes 38 for cooling the stator 34 are also coupled to the stator 34 from the opposing side and extend into a front liquid cooled condenser chamber 80. Here, both the liquid cooled front condenser chamber 80 and rear condenser chamber 71 are in fluid communication with an inlet 70 for receiving cooling fluids and a liquid outlet 72 for dispensing the fluids. A radial fan 46 can, again, be provided adjacent the power electronics 36, drawing air flow through the housing 30 and rotor 32. The air is then redirected by the radial fan 46 through the power electronics 36, drawing air flow through the housing 30 and rotor 32. A cooling jacket fin 50 can be provided on the stator 34 for additional cooling. Although separate heat pipes 38 can extend from the stator 34 into the rear and front liquid cooled condensers 71 and 80, individual heat pipes 38 can be sized to extend from the front liquid cooled condenser 80, through the stator 34, and into the rear liquid cooled condenser 71.

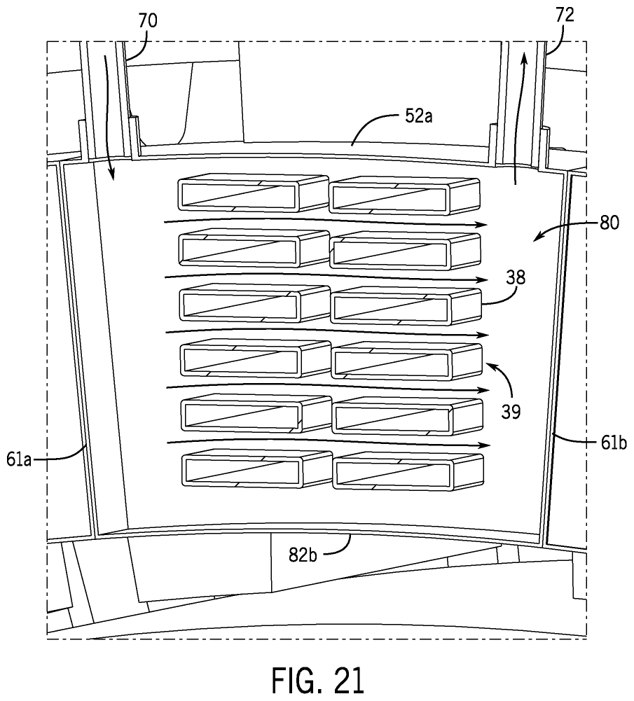

Referring now to FIG. 21, a cutaway view of the liquid cooled front condenser chamber 80 is shown. As illustrated here, the liquid cooled front condenser chamber 80 has substantially straight vertical right and left side walls 61a and 61b, and substantially straight upper and lower plates 82a and 82b. The coolant inlet 70 and outlet 72 are formed at opposing ends of the upper plate 82a, on opposing sides of a bank 39 of heat pipes 38. Fluids, therefore, are directed into the front condenser chamber 80, and flow horizontally across the rectangular heat pipes 38, exiting through the outlet 72. Fluid flow, therefore, is generally directed across the largest surfaces of the bank 39. The liquid cooled rear condenser chamber 71 is constructed as described above with reference to FIG. 17.

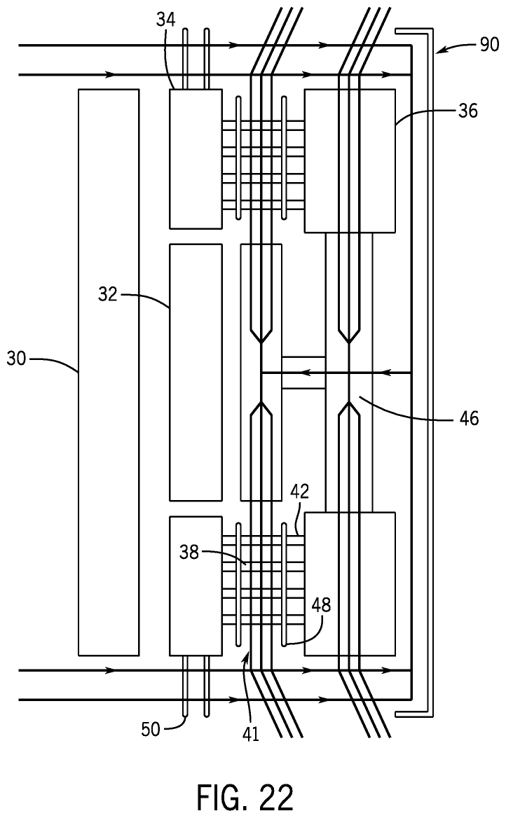

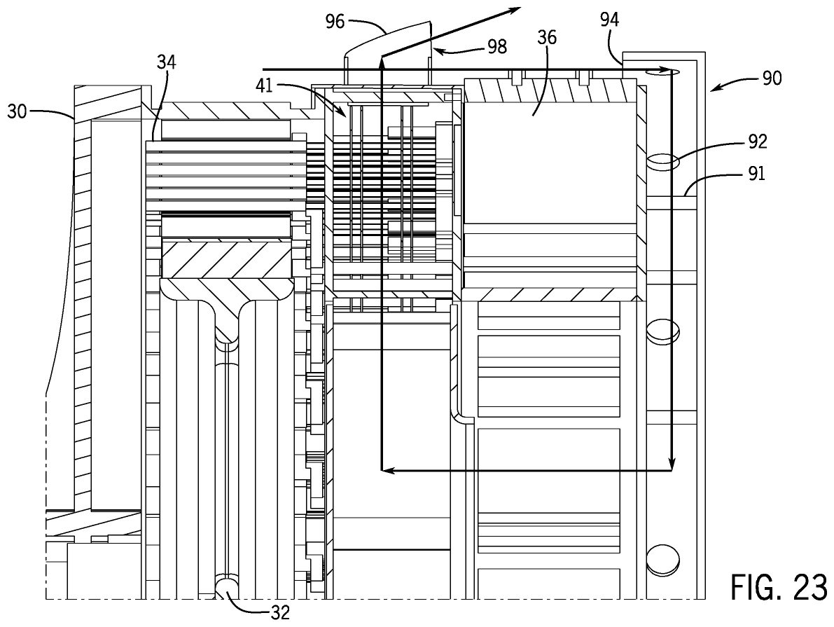

Referring now to FIGS. 22 and 23 a schematic drawing and a cutaway side view of motor 10 using a single chamber air cooling condenser similar to that of FIG. 10 are shown. Like numerals are used to reference similar parts in the description above. Referring first to FIG. 22, the motor 10 comprises a housing 30, rotor 32, stator 34, and power electronics 36, as described above. Here, heat pipes 38 for cooling the stator 34 extend from the stator 34 and heat pipes 42 for cooling the power electronics 36 extend from power electronics 36 into the air cooled condenser chamber 41 between the power electronics 36 and stator 34. A radial fan 46 is, again, provided adjacent the power electronics 36, drawing air flow from the air in the diverter plate 90 and redirecting it into the air cooled condenser chamber 41 and the power electronics 36. A cooling fin 48 can be provided on the heat pipes 38, and a cooling jacket fin 50 can be provided on the stator 34 for additional cooling. As illustrated here, an air diverter 90 can be coupled to the outside of the housing 30, as described more fully below. The corresponding components are similarly illustrated in the cutaway view of FIG. 23. Referring again to FIG. 22, in an alternative embodiment, the relative position of the power electronics 36 and stator 34 can be reversed.

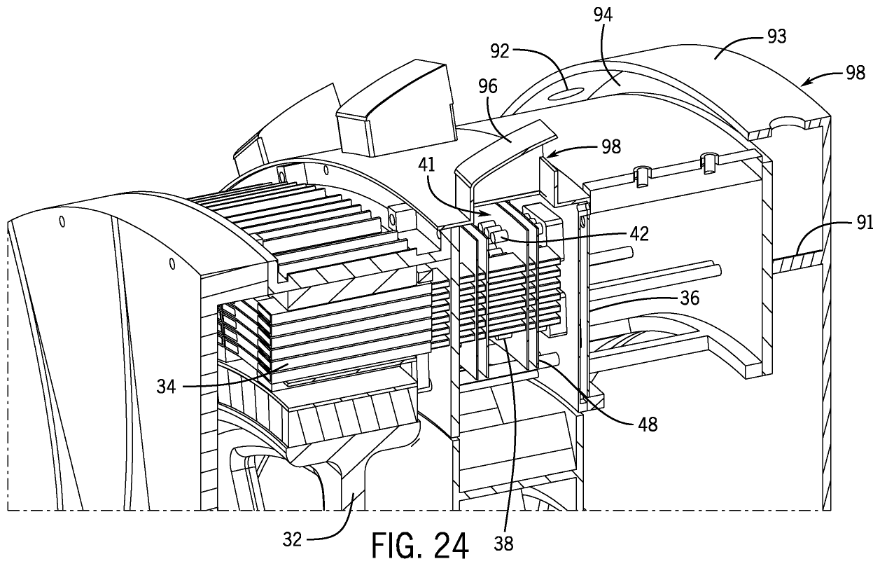

Referring again to FIG. 23 and now also to FIG. 24, the air diverter 90 can be coupled to an end of a housing 30 of the machine 10. As illustrated here, the air diverter 90 is coupled to the housing 30 through a series of supports 91. The air diverter includes a flange 93 that extends over the outer surface of the housing 30 forming an open space or channel 94 between an outer surface of housing 30 and the flange 93 of the air diverter 90. A plurality of apertures 92 can be spaced around the flange 93 to allow debris to exit the system. The air cooled condenser chamber 41 here includes a plurality of spaced outlet ducts 96 which include an angled outer surface to direct air flow through an aperture 98 formed in a side of the outlet 96, and away from the opening 94 in the diverter 90 so that the air is not reused. Air flow through the chamber 41 is illustrated by the directional arrows in FIG. 23. As illustrated here, air flow across the housing 30 which can be, by way of example, caused by aircraft movement, is directed to the space 94 formed between the housing 30 and air diverter flange 93. Air is directed to the cooling chamber 41 through one or more opening in the enclosure for the power electronics 36 and is directed through the opening 98 in outlet 96 at an angle, forcing the air to not flow back toward the opening 94 formed between housing 30 and diverter 90.

The condensers described above can be constructed using 3D printing techniques including, by way of example, selective laser sintering (SLS), and multi-jet fusion (MJF). Alternatively, the condensers can be constructed using injection molding, which can use materials such as nylon and Acrylonitrile Butadiene Styrene (ABS). Portions of condensers can be interconnected using epoxy, vapor smoothing, or other sealing techniques. The fins described above can be constructed using aluminum materials including, but not limited to, aluminum 6061 or aluminum 6063. Although air and liquid are described above, fluids such as 50-50 water ethylene glycol (WEG) and Jet Oil II from Exxon Mobil corporation of Houston, Texas can also be used.

It should be understood that the methods and apparatuses described above are only exemplary and do not limit the scope of the invention, and that various modifications could be made by those skilled in the art that would fall under the scope of the invention. For example, although the conductors are illustrated in round and rectangular configurations, other shapes can be used. In particular, polygons that occupy the slot area have been shown to be effective. Further, although a radial fan is described above, it will be apparent that other types of fans, such as axial fans, centrifugal fans, and propellor fans can also be used. Further, although air is discussed above, various other types of gas or fluid coolants can also be used. Although a single housing is described, it will be apparent that the housing may be constructed of a series of enclosures that are connected together, and that the term is used herein to identify the outer surfaces enclosing the described components. Accordingly, the invention is not to be seen as limited by the foregoing description but is only limited by the scope of the appended claims.

1. An electrical machine comprising:
a stator comprising a plurality of windings each of the windings comprising a first plurality of legs connected to a second plurality of legs to form a coil configuration, each of the legs in the first plurality of legs and each of the legs in the second plurality of legs comprising a duct extending from a first end to a second end of a length portion of the leg;
a rotor comprising a plurality of permanent magnets;
power electronics, the power electronics providing an AC power supply to the stator causing the rotor to rotate; and
a fluid cooled chamber extending between the power electronics and the stator, the fluid cooled chamber comprising a plurality of heat pipes coupled the stator and/or the power electronics.

2. The electrical machine of claim 1, further comprising a second cooling chamber the second cooling chamber on an opposing side of the stator from the first chamber, the second cooling chamber comprising a second plurality of heat pipes extending from the stator.

3. The electrical machine of claim 1, further comprising a fan in fluid communication with the fluid cooled chamber to provide a cooling fluid to the fluid cooled chamber and directing air through the power electronics.

4. The electrical machine of claim 1, wherein the fluid cooled chamber further comprises a fluid inlet in communication with a gas or liquid fluid source and the fluid outlet is configured to expend the gas or liquid fluid source from the fluid cooled chamber.

5. The electrical machine of claim 1, wherein the heat pipes include an outer wall surrounding a vapor space, and wherein a wick extends between the outer wall and the vapor space.

6. The electrical machine of claim 1, wherein at least one of the plurality of heat pipes is coupled to a cooling plate mounted adjacent the power electronics.

7. The electrical machine of claim 1, wherein the fluid cooled chamber comprises first and second opposing walls, a fluid inlet is provided in the first of the first and second opposing walls and a fluid outlet is provided in the second of the first and second opposing walls, and wherein the fluid inlet is laterally offset from the fluid outlet such that fluid flows across the plurality of heat pipes in the fluid cooled chamber as fluid moves from the fluid inlet to the fluid outlet.

8. The electrical machine of claim 1, wherein the fluid cooled chamber comprises a plurality of fins, and the plurality of heat pipes extends through the plurality of fins.

9. The electrical machine of claim 1, wherein the fluid cooled chamber comprises first and second opposing walls, a fluid inlet is provided in the first of the first and second opposing walls adjacent a first side of the plurality of heat pipes and a fluid outlet is provided in the first of the first and second opposing walls adjacent a second side of the plurality of heat pipes, wherein fluid flows across the plurality of heat pipes in the fluid cooled chamber from the fluid inlet to the fluid outlet.

10. The electrical machine of claim 1, wherein at least one of the plurality of heat pipes is sized and dimensioned to be received in an opening formed in one of the plurality of legs of the stator.

11. The electrical machine of claim 10, wherein the at least one of the plurality of heat pipes is rectangular in cross section.

12. The electrical machine of claim 1, wherein at least one of the plurality of heat pipes terminates at a mounting surface for mounting the power electronics.

13. The electrical machine of claim 12, wherein the at least one of the plurality of heat pipes is round in cross section.

14. The electrical machine of claim 3, further comprising a housing, and wherein the housing comprises apertures for directing air flow from the fan.

15. The electrical machine of claim 1, wherein the fluid cooled chamber comprises side walls with openings for air flow.

16. The electrical machine of claim 1, wherein the fluid cooled chamber comprises walls that include a fluid inlet and a fluid outlet for directing a flow of liquid, and side walls that are solid in construction to contain liquid.

17. The electrical machine of claim 1, further comprising a cooling jacket covering the stator.

18. The electrical machine of claim 7, further comprising a diverter plate extending over the fluid inlet to direct the flow of fluid.

19. The electrical machine of claim 7, wherein at least one of the plurality of heat pipes is received in the duct in one of the plurality of windings in the stator.

20. The electrical machine of claim 1, wherein the rotor is coupled to a propellor.

21. The electrical machine of claim 1, wherein the fluid chamber is an air cooled chamber, and wherein an air diverter is coupled to a housing of the electrical machine, the air diverter forming a channel for directing air flow caused by movement of the machine to an opening in the housing and into the air cooled chamber, and wherein the air cooled chamber includes at least one air outlet duct that is angled to cause the air exiting the air cooled chamber from re-entering the channel of the air diverter.

22. An electrical machine comprising:
a stator comprising a plurality of windings each of the windings comprising a first plurality of legs connected to a second plurality of legs to form a coil configuration, each of the legs in the first plurality of legs and each of the legs in the second plurality of legs comprising a duct extending from a first end of a length portion of the leg to a second end of the length portion of the leg;
a rotor comprising a plurality of permanent magnets,
power electronics, the power electronics providing an AC power supply to the stator causing the rotor to rotate; and
a first fluid cooled chamber extending between the power electronics and the stator, the first fluid cooled chamber comprising a plurality of heat pipes coupled within the ducts in the plurality of windings in the stator and a second plurality of heat pipes coupled to the power electronics; and
a second fluid cooled chamber extending from an opposing side of the stator winding, the second fluid cooled chamber comprising a second plurality of heat pipes extending from an opposing end of the ducts in the plurality of windings of the stator.

23. An electrical machine comprising:
a stator comprising a plurality of windings each of the windings comprising a first plurality of legs connected to a second plurality of legs to form a coil configuration, each of the legs in the first plurality of legs and each of the legs in the second plurality of legs comprising a duct extending from a first end of a length portion of the leg to a second end of the length portion of the leg;
a rotor comprising a plurality of permanent magnets, the rotor coupled to a propellor to rotate the propellor;
power electronics, the power electronics providing an AC power supply to the stator causing the rotor to rotate; and
a first fluid cooled chamber extending between the power electronics and the stator, the first fluid cooled chamber comprising a plurality of heat pipes coupled within the ducts in the plurality of windings in the stator and a second plurality of heat pipes coupled to the power electronics.
